(19) United States
(12) Patent Application Publication
(10) Pub. No.: US 2013/0091072 A1
(43) Pub. Date: Apr. 11, 2013

(54) ALGORITHM FOR POST-TRADE ANALYSIS AND FORMULATION OF OPTIMIZED STRATEGY FOR SUBSEQUENT TRADES

(71) Applicants: Milan BORKOVEC, Boston, MA (US); Hitesh MITTAL, Edison, NJ (US); Scott J. KARTINEN, New York, NY (US)

(72) Inventors: Milan BORKOVEC, Boston, MA (US); Hitesh MITTAL, Edison, NJ (US); Scott J. KARTINEN, New York, NY (US)

(73) Assignee: ITG SOFTWARE SOLUTIONS, INC., Culver City, CA (US)

(21) Appl. No.: 13/268,253

(22) Filed: Oct. 7, 2011

(51) Int. Cl. G06Q 40/04

(52) U.S. Cl. 705/36 R

(57) ABSTRACT

A computer-implemented system and method for using market data and analysis of previous trades to improve return on investment in one or more future trades. Historical trading data relating to a fund is collected and used to identify an alpha profile of the fund. Outcomes of a plurality of strategies for trading a security are simulated based on the identified alpha profile, and an optimized trading strategy is determined based on the results of the simulations.

### FIELD OF THE INVENTION

This invention relates generally to methods and systems for implementing electronic trading of portfolios of assets in a financial market. More particularly, the invention relates to methods and systems for determining the optimum trading style for implementing trades in asset(s) under management, given a particular portfolio or fund strategy.

### BACKGROUND OF INVENTION

A securities trading mechanism can be thought of as a set of protocols that translate the latent demands of a group of investors into realized prices and quantities. In addition to the national and regional exchanges, there exist a number of proprietary equity trading mechanisms, such as electronic communication networks (ECNs), which are tailored to handle the specialized needs of sophisticated investors and traders. Further, investors and traders often employ a specific strategy for executing trades, especially in situations involving aggregating client orders for a given fund. Many such strategies are well known.

Algorithmic trading, or so-called “program trading,” has been known for many years. According to such program trading, various factors such as timing, volume, individual price trends, market trends, sector trends, etc. are taken into account according to a series of rules defined by the algorithm, which then determine whether to enter trade orders and which parameters to select for those trade orders. The factors considered and the manner in which those factors are incorporated or weighted in a trading algorithm are a function of the particular strategy developed by the investor.

One example of an equity trading strategy entails executing trades with a goal of achieving a volume weighted average price (VWAP), as described in U.S. Pat. No. 7,613,647, the contents of which are incorporated herein in their entirety. The VWAP of a stock is the average price of trades of the stock over the course of the day weighted according to the number of shares traded at each price. Thus, for example, 1000 shares traded at 56.5 are weighted five times as heavily as 200 shares traded at 54.25, thus yielding a VWAP of 56.125. The VWAP strategy entails dividing the trading day into a number of equal time bins such as, for example, bins of half-hour increments. Historical market data relating to the stock to be traded is then used to determine a placement of orders within each time bin. The VWAP server algorithm may be useful for those clients who wish to trade a block of shares of a particular security over the course of a market day (or portion thereof) at a price near the security's VWAP for that day (or for that portion). The VWAP benchmark is desirable for such traders in that it allows evaluation of the success of a trader's approach to achieving reasonable execution prices.

Another example of a trading strategy is known as Short-term Price Improvement (SPI). The SPI strategy is designed to complete all orders within a maximum time frame specified by the customer, preferably 30 minutes or less, while optimizing the transaction price within the desired time frame. In other words, clients submitting orders stating “buy 5,000 shares of IBM within 20 minutes” to a server running the SPI strategy are essentially stating a desire to purchase 5,000 shares of the stock at the lowest price within the 20 minute time frame. In the SPI strategy, a variety of market indicators are continuously received and monitored in order to determine the best way to execute a given client order. Depending upon short-term price forecasts and market timing analysis based upon these market indicators, any of three separate courses of action may be taken: 1) an attempt to execute the client order as a market order, 2) an attempt to execute the client order as a limit order having a price set at one of various levels of aggressiveness, or 3) a delay to the client order for a short period in order to wait to see how the market indicators change.

Accordingly, the strategy selected for trade execution is an important factor in the resulting return on investment. Previous work by the present inventors indicates that the trading and/or investment approach, or style, of certain clients may have a major impact on their trading costs quantified as the implementation shortfall. When the trading costs are higher, this translates into a decrease in investment performance, or “alpha leakage.” For example, investors that invest into momentum stocks often experience higher costs. Accordingly, there is a need to accomplish the clients' trading objectives while reducing transactional costs, thereby improving the effective rate of return on investment. In particular, there is a need in the field to provide a model that would recommend an optimal trading strategy to a trader based on the trader's risk tolerance and other considerations such as the time horizon over which the trade is to be completed. The present invention fills this need by providing a manner of estimating changes in impact from changes in order timing, finding optimal strategy given competing forces of alpha and impact, and customizing an algorithm that precisely implements this strategy.

### SUMMARY OF THE INVENTION

According to an embodiment of the present invention, a method for determining a trading style and implementing trades in asset(s) under management for a portfolio or a fund. The method includes measuring the net price movement of a target order (or portfolio of orders) at any moment of time during the order execution horizon, obtained by removing the market, sector and industry price movements, or, more generally, other systematic factors that are deemed to be independent of the trader's actions. The net price movements (returns) are subsequently split into the trader's own price impact and alpha, and various trading strategies are simulated taking into account the trader's alpha profile and the price impact due to implementation of those trading strategies. Based on the simulations, an optimal strategy can be designed and/or discovered.

According to one aspect of the invention, a computer-implemented method for trading a security is provided. The method includes the steps of: (a) collecting historical trading data pertaining to a fund's trading; (b) using a computer to identify an alpha profile of the fund; and (c) using a computer to determine an optimal trading strategy for the security based on the identified alpha profile. The step of using a computer to determine an alpha profile includes measurement of intraday price movement from the collected historical trading data and removing from the measured price movement a market effect, a sector effect, an industry effect, and other systematic factors affecting the price of the security and unrelated to own price impact of the trader.

The historical trading data may include price movement data and trade imbalance data. The step of using a computer to optimize may include simulating outcomes for a plurality of predetermined strategies for trading of the security based on the identified alpha profile. The step of using a computer to determine an optimal strategy may further include selecting one of the simulated strategies based on a result of the simulating.

Alternatively, the step of optimizing may further include using a result of the simulating to determine a trading strategy, customized to the fund's trading style. The method may further include the steps of obtaining recent trading data during an implementation of the customized trading strategy; and using the obtained recent trading data to adjust the customized trading strategy prior to the order completion.

In another aspect of the invention, an electronic trading platform can be provided. The trading platform may include a trading interface executed on a trader desktop device and a server computer coupled to the trading interface and coupled to at least one electronic communication network. The server computer is configured to: (a) collect historical trading data relating to a fund; (b) identify an alpha profile of the fund; and (c) determine an optimal strategy for trading a security based on the identified alpha profile. The server computer is further configured to identify an alpha profile by measuring the price movement of the security from the collected historical trading data and removing from the measured price movement the systematic pricing factors, which may include, but not limited to, a market effect, a sector effect, and an industry effect.

The historical trading data may include price movement data and trade imbalance data. The server computer may be further configured to determine an optimal strategy by simulating inputs and outputs for a plurality of predetermined hypothetical strategies for trading the security based on the identified alpha profile. The server computer may be further configured to select one of the simulated strategies based on the analysis of the simulated outcomes.

The server computer may be further configured to use a result of the simulating to determine a customized trading strategy. The server computer may be further configured to obtain real time data during an execution of the customized trading strategy, and to use the obtained real time trading data to adjust the customized trading strategy prior to completion of the order.

In yet another aspect, the invention may provide a non-transitory computer readable medium having stored thereon computer executable instructions for trading a security when executed by performing the following operations: (a) collecting historical data pertaining to trading activity of a fund; (b) identifying an alpha profile of the fund; and (c) determining an optimal trading strategy for the order (or portfolio of orders) based on the identified alpha profile. The instructions for identifying an alpha profile include instructions for measuring the price movement of the security from the collected historical trading data and removing from the measured price movement the systematic pricing risk factors (which may include, but are not limited to, the price movements due to a market effect, a sector effect, and an industry effect).

The historical trading data may include price movement data and trade imbalance data. The instructions for optimizing may include instructions for simulating a plurality of predetermined hypothetical strategies for trading the security based on the identified alpha profile. The instructions for optimizing may further include instructions for selecting one of the simulated strategies based on the analysis of simulated outcomes.

Alternatively, the instructions for optimizing may further include instructions for using a result of the simulating to determine a customized trading strategy. The computer executable instructions may further include instructions for obtaining real time trading data during an implementation of the customized trading strategy; and instructions for using the obtained real time trading data to adjust the customized trading strategy prior to completion of the order.

The present invention will become more fully understood from the forthcoming detailed description of preferred embodiments read in conjunction with the accompanying drawings. Both the detailed description and the drawings are given by way of illustration only, and are not limitative of the present invention as claimed.

### BRIEF DESCRIPTION OF THE DRAWINGS

FIG. 1 is a block diagram of a system for post-trade analysis and formulation of subsequent trades according to a preferred embodiment of the present invention;

FIGS. 2 and 3 are graphs of the expected standardized trade imbalance data for different trade sizes under normal market conditions;

FIGS. 4-7 are graphs of estimated percentiles of standardized trade imbalance data under normal market conditions;

FIG. 8 is a graph of estimated price trajectories for a first exemplary set of market conditions;

FIG. 9 is a graph of trading schedules relating to the example illustrated in FIG. 8;

FIG. 10 is a graph of estimated costs for different trading strategies relating to the example illustrated in FIG. 8;

FIG. 11 is a graph of estimated price trajectories for a second exemplary set of market conditions;

FIG. 12 is a graph of trading schedules relating to the example illustrated in FIG. 11;

FIG. 13 is a graph of estimated costs for different trading strategies relating to the example illustrated in FIG. 11;

FIG. 14 is a graph of estimated price trajectories for a third exemplary set of market conditions;

FIG. 15 is a graph of trading schedules relating to the example illustrated in FIG. 14;

FIG. 16 is a graph of estimated costs for different trading strategies relating to the example illustrated in FIG. 14;

FIG. 17 is a graph of estimated price trajectories for a fourth exemplary set of market conditions;

FIG. 18 is a graph of trading schedules relating to the example illustrated in FIG. 17;

FIG. 19 is a graph of estimated costs for different trading strategies relating to the example illustrated in FIG. 17;

FIG. 20 is a graph of estimated price trajectories for a fifth exemplary set of market conditions;

FIG. 21 is a graph of trading schedules relating to the example illustrated in FIG. 20;

FIG. 22 is a graph of estimated costs for different trading strategies relating to the example illustrated in FIG. 20;

FIG. 23 is a flow diagram of the steps involved in a method for performing post-trade analysis and formulation of subsequent trades according to a preferred embodiment of the present invention;

FIG. 24 is a graph of observed cumulative returns, cumulative returns net of the market, sector, and industry effects, and an estimated cumulative alpha profile for an exemplary set of buy transactions executed for a particular fund in a particular year;

FIG. 25 is a graph of observed cumulative returns, cumulative returns net of the market, sector, and industry effects, and an estimated cumulative alpha profile for an exemplary set of sell transactions executed for a particular fund in a particular year;

FIG. 26 is a graph of cumulative intraday market volume as a fraction of daily market volume versus cumulative shares of an order traded as a fraction of total fill size of that order for a family of hypothetical trading strategies;

FIG. 27 is a graph of average cost estimates for a family of trading strategies for an exemplary set of buy transactions executed for a particular fund in a particular year; and

FIG. 28 is a graph of average cost estimates for a family of trading strategies for an exemplary set of sell transactions executed for a particular fund in a particular year.

### DETAILED DESCRIPTION OF THE PREFERRED EMBODIMENTS

According to one aspect of the present invention, a novel and nonobvious computer-implemented methodology is provided for analyzing executions of a portfolio manager's electronic trade orders and for generating recommendations for improving the investor's trading aggressiveness or urgency, and, more generally, trading style (i.e., the trading desk's style of implemented executions of a portfolio manager's trade orders). The following describes a non-limiting, inventive framework for decoupling general market movement and the impact of other market participants from the impact of a specific client, and thus enables the analysis of costs of alternative hypothetical trading strategies.

In the context of the present invention, it should be noted that “trading strategies” and “trading style” refer to activity of the trader, while “fund strategy” refers to the strategy of a portfolio manager or fund. An exemplary trading strategy could be a benchmarked algorithm, such as VWAP, or other trading strategy.

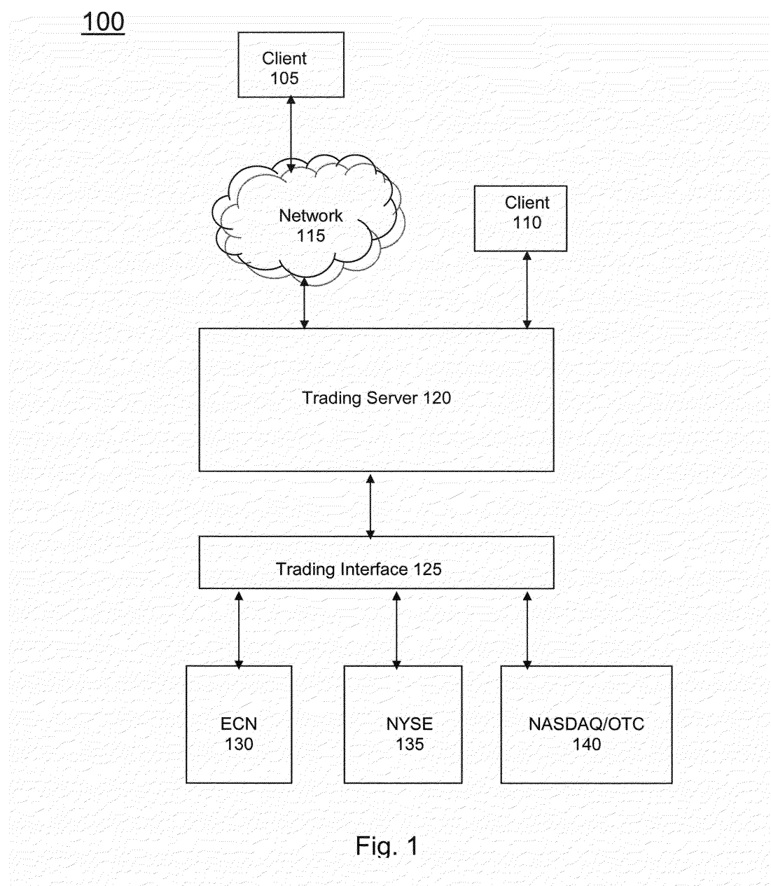

Referring to FIG. 1, a block diagram of a system 100 according to an embodiment of the present invention includes a trading server 120. The server 120 is in communication via a trading interface 125 with various trading venues, such as an Electronic Communication Network (ECN) 130, the New York Stock Exchange 135, the NASDAQ/Over-The-Counter (OTC) market 140, and other like markets and/or exchanges. A trading computer client 110 may be composed of a personal computer, workstation, or similar device executing a trading system, such as an order management system (OMS) or execution management system (EMS) that provides direct market access, and which may be directly coupled to the server 120. Other computer clients, such as client 105, may be coupled to the server 120 through a distributed communication network 115, which may be the Internet, a Wide Area Network (WAN), a Local Area Network (LAN), or any other similar type of communication network.

The server 120 may include a data processing system, which may include one or more microprocessors and/or one or more circuits, such as an application specific integrated circuit (ASIC), Field-programmable gate arrays (FPGAs), etc; and a data storage system, which may include one or more non-volatile storage devices and/or one or more volatile storage devices (e.g., random access memory (RAM)). In embodiments where the data processing system includes a microprocessor, computer-readable program code may be stored in a non-transitory computer-readable medium, such as, but not limited to, magnetic media (e.g., a hard disk), optical media (e.g., a DVD), solid state memory devices, etc. In some embodiments, computer-readable program code is configured such that when executed by a processor, the code causes the trading server 120 to perform method steps such as those described below, to implement the features of the present invention. In other embodiments, the trading server 120 is configured to perform steps described above without the need for a code. For example, the data processing system may consist merely of one or more ASICs. Hence, the features of the present invention described above may be implemented in hardware and/or software. For example, in particular embodiments, the functional components of the trading server 120 described above may be implemented by the data processing system executing computer instructions, by the data processing system operating independent of any computer instructions, or by any suitable combination of hardware and/or software.

In an exemplary embodiment of the invention, a client-specific trading strategy is created, designed or discovered as a function of an “alpha profile” of the associated portfolio manager or fund, or the fund strategy. Alpha, or a, refers to a measure of the risk-adjusted performance of a given investment in a security that factors in the idiosyncratic risk of the security but not the overall market risk and other systematic risk factors of the security. A general fund strategy may involve, for example, favoring certain market sectors or certain types of securities (e.g., capitalization level) or certain specific securities, and also particular levels of certain securities' attributes (e.g., high volatility versus low volatility). Fund-specific historical data can be used to assess these factors, and also to assess the performance that the fund strategy has yielded. The alpha profile of the fund can then be determined based on the fund's historical performance. Once an alpha profile is determined, then, for a proposed trade order for asset(s) in the fund, a specific algorithm or strategy can be created in order to optimize execution of an order or a series of orders within a particular time frame, such as, for example, a single trading day.

The process of identifying the alpha profile requires that the overall market risk and other systematic risk factors be effectively removed from the returns in assessing the performance of a trading strategy. For a given security, there are numerous factors that are typically understood as relating to the overall market risk, such as, for example, the price-to-earnings ratio, the dividend payout ratio, the historical return on investment over the past x months, etc. These factors may cause an institutional trader to expect a particular amount of price movement in the security to occur. Further, sector effects and industry effects may also be effectively removed as systematic factors. In addition, to the extent that a large quantity of the given security may be traded by other institutional traders, the expected price movement may be amplified or adjusted by a multiplicative factor related to this additional quantity. Thus, because the expected amount of price movement and the potential adjustment thereof are due to the overall market risk of the security, the calculation of alpha for the security must be based solely on price movement that is not attributable to these systematic factors.

Further, in an exemplary embodiment of the invention, a distinction is made between a traditional notion of alpha and a short-term evaluation of alpha in the case of the present invention. Traditionally, alpha has been measured over a three-month to six-month time frame. However, the present invention contemplates the provision of an algorithm which optimizes a trading schedule over a relatively short time frame, such as, for example, a single trading day. Thus, the determination of the client-specific alpha profile is based on a short-term alpha.

Preferably, optimizing a trading strategy entails simulating inputs and outcomes for a plurality of hypothetical strategies for executing an order to trade a security based on the identified alpha profile. The results of the simulations can then be used to determine an optimum trading strategy for executing an order to trade the security and one of the hypothetical strategies may be selected. Alternatively, a customized trading strategy can be created. In addition, when a customized trading strategy is used, it can be further adjusted based on the real time trading data obtained during the course of the execution of the order according to the strategy.

In an exemplary embodiment of the invention, for relatively large order sizes (e.g., greater than 2000 shares of a given stock), the components of the Smart Cost Estimator (“SCE”) and the associated strategy optimizer devised by assignee of the present invention, ITG SOFTWARE SOLUTIONS, INC., may be employed to find how algorithm choices can be tuned to improve client performance. For small order sizes (e.g., less than 200 shares of a given stock), Level 1 market data may be used directly without adjusting for the impact relating to the small order. For medium order sizes, a hybrid approach may be used.

In an exemplary embodiment, each order can be divided into child orders, or order portions, each of which can be assigned to a time bin during which the corresponding child order is executed. For each order, the realized trade imbalances for the given trader and for the overall market can be calculated in each bin. A stock return net of the market effect and other systematic factors for a given trade imbalance will be referred to herein as “the F function” of SCE, and an effective spread relative to the price at the beginning of a bin will be referred herein as “the G function” of SCE. The joint distribution of the F and G functions can be determined given the realized market trade imbalance in each bin and the realized market conditions in the preceding bins. For each order and each hypothetical strategy, a distribution of the hypothetical trade imbalance of the client can be determined using the trading style of a client.

The return in each bin typically varies for different strategies. It is assumed that the realized return is drawn from the return distribution given by the SCE F function. If a different number of shares is traded in a bin under the identical market conditions, then the same percentile of the conditional return distribution will be realized, but drawn from the new distribution given by the F function distribution calculated at the trade imbalance corresponding to this new number of shares. The average execution price in each bin can be calculated as described above the bin return, using the G function distribution in place of the F function. Optimized strategies can then be compared to the original execution strategies, and the relative differences can be aggregated.

In a preferred embodiment, electronic trade orders are collected from the fund, and data relating to the electronic trade orders is used as an input to an optimization algorithm, which is described in detail below. The algorithm can be executed to produce an optimal strategy for each order. The optimal strategy can be determined based on minimizing the total implementation shortfall, given the constraints relating to the electronic trade orders (e.g., that the orders are traded in one day) or other constraints, such as minimum and maximum participation. Outcomes of the optimal strategies are compared to outcomes of the original realized trading strategies, and aggregated. Recommendations are made based on this aggregated comparison.

The F and G functions provide estimates of the distributions for the returns and the extra cost net of the price drift in each five-minute interval of the day. The estimates are conditioned on the contemporaneous trade imbalances (i.e., buy-initiated minus sell-initiated trades) and market conditions (i.e., volatility, volume and spread). As further described below, the F and G functions are estimated from Level 1 market data, and the contemporaneous trade imbalance is determined and estimated from client execution data and augmented by some theoretical considerations.

The purpose of the F function is to obtain the distribution of stock returns, or price impact, for a given trade imbalance, after the market effect and other systematic factors have been extracted. In order to estimate the F function, the following steps can be executed: First, market data are gathered for a specified period, and the gathered market data are divided into bins. No order data is required in this first step. Second, in each bin, the trade imbalance and market conditions for each stock are obtained. Third, for a given trade imbalance, the stock returns net of the market effect and other systematic factors in that bin are obtained for the observed market conditions. Fourth, the F function uses this data to determine a probability distribution of the stock return for the determined stock trade imbalance and the observed market conditions. Assuming that the trade imbalance is known, this procedure can be used to determine the price impact (i.e., distribution of the stock return net of the market effect and other systematic factors) for a given order size in a given stock for given market conditions in a given bin.

In an embodiment of the present invention, the dependence of stock returns on order sizes may be estimated directly. However, this estimate may be less accurate if there is insufficient order data, especially because the effects of given market conditions and given order sizes are the subject of further study. By contrast, if the distribution of trade imbalances for a given order size is estimated, there is a nearly unlimited amount of market data that could be used to study the dependence of returns on trade imbalances. If the amount of order data is sufficient, direct estimates of the dependence of stock returns on order sizes are generally more stable, provided that the order data is representative of the market conditions used to obtain the F function.

As described above, the F function can be used to predict the return of the stock (net of the market, sector, industry effects, as well as other systematic factors) for the given number of shares traded. However, the F function does not predict the average execution price in the bin. Across the entire universe, it has been observed that the average execution price is approximately equal to half of the stock return, but for a given order size in a bin, the average execution price may be different. For example, if a smaller order is being traded, then in many instances, the smaller order would often come from a liquidity supplier, and hence, the average execution price is likely to be lower than half of the stock return. As another example, if a larger order is being traded, then the larger order would often be a demander of liquidity, and hence, the average execution price is likely to be higher than half of the stock return. Therefore, it is desirable to determine an estimate of how much more or less than half of the stock return the average execution price relative to the price at the beginning of the bin will be for the given order size and for the given market conditions.

The purpose of the G function is to determine the effective spread relative to the price at the beginning of a bin. In order to estimate the G function, the following steps are executed: First, the market data for each stock in each bin is observed. Second, the stock returns and the volume-weighted average execution prices are observed. Third, the effective spread (i.e., average execution price minus half of the stock return) is regressed against market conditions and trade imbalances. In one embodiment, a highly nonlinear regression model is estimated. In this manner, the G function represents a distribution function that estimates an extra cost for a given value of trade imbalance and given market conditions.

The purpose of the H function is to characterize the distribution of possible outcomes of the next-five-minute interval standardized trade imbalances for a given trade size and given market conditions (i.e., volatility and volume). In a preferred embodiment of the present invention, the distribution of the H function is also determined.

After a trade of a child order has been completed, for a given order and for each bin, the trade size and the realized trade imbalance in that security are known. The realized trade imbalance is calculated by subtracting the number of sell-initiated shares from the number of buy-initiated shares and then dividing this difference by a standardization factor. In addition, the market conditions, such as volatility and volume, are also known. These known quantities provide a basis for making a more educated prediction for the conditional post-trade mean of the standardized trade imbalance for any hypothetical trade size. In a preferred embodiment, this prediction may be determined by using the following process:

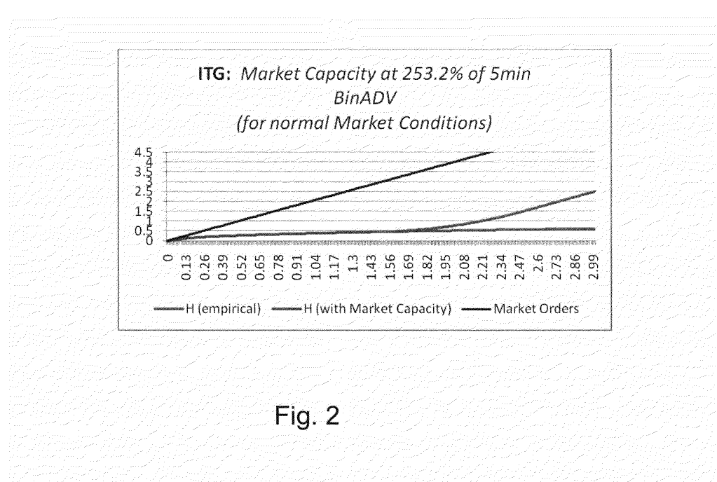

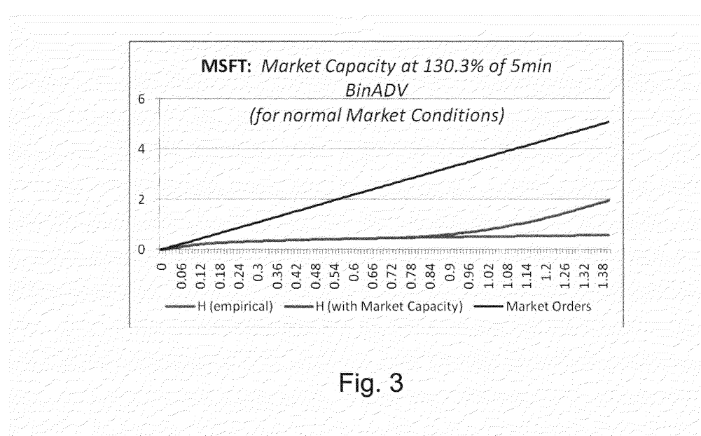

First, for given market conditions and a given number of shares traded (normalized into percentage of average daily volume, or % ADV, for the bin), the estimated mean of the standardized trade imbalance is determined The estimated mean is a component of the H function. It has been observed that generally, for given market conditions and holding all other variables constant, the trade imbalance varies directly with the participation rate. In a preferred embodiment of the present invention, the estimated mean of the trade imbalance is determined to be equal to the empirical estimate provided by the SCE mean estimator for any trade size that is less than or equal to the maximum of five times the observed trade size and the size that pushes the expected trade imbalance above the 80^{th} percentile of the unconditional standardized trade imbalance distribution. For trade sizes above this threshold, the estimated mean is determined by using a mixture of the empirical mean and a theoretical mean, for which the weights are determined based on the chosen participation rate. In particular, it is assumed that there exists a “market capacity” threshold above which the client can further increase the fill rate only by executing market orders. This threshold depends on the overall market volume and market volatility in the given name. Referring to FIGS. 2 and 3, the graphs of expected standardized trade imbalances for alternative order sizes under normal market conditions are shown. In each of FIGS. 2 and 3, the graphs show the empirical means in blue and the estimated means in red. For comparison, the standardized expected trade imbalance curve based on trading market orders only is shown in black.

In the second step of the process, the deviation Δ^{realized} of the observed standardized trade imbalance from its estimated mean obtained in the first step is measured. Then, in the third step, the estimated mean for the new hypothetical trade size is determined as described above. In this aspect, it is assumed that, given the same market conditions and the trading style of the client, the best guess for the trade imbalance for the new trade size will be equal to the sum of the estimated mean for the new hypothetical trade size and the component Δ. Further, the component Δ is assumed to be a function of Δ^{realized} and the hypothetical trade size. More precisely, it is assumed that:

Δ=Δ^{realized} for all hypothetical trade sizes smaller or equal to the observed trade size, and

Δ→0 as the trade size approaches the floating number of shares of the company.

The above assumptions are based on the following: if the trade is so large as to approximate the entire market, then the distribution of the standardized trade imbalance must converge to a single point, which is by definition equal to the the mean. Setting Δ=Δ^{realized} is based on an implicit assumption that on average, providers and demanders do not react to the decline in participation of a given fund manager in the market (i.e. they do not change their trading style, on average, conditioned on the discussed factors). As a result, the estimated deviation from the mean for hypothetical trade sizes that are smaller than the actual previous trade size remains constant. This appears to be a realistic assumption for execution of a small trade in a five-minute bin. The same is arguably true when trading of a large portion of shares is successfully executed in dark pools (i.e., in a manner that cannot be seen by a potential market participant and therefore, the existence of the dark pool can be imputed only ex post facto). Given the widespread nature of discretionary trading for large order sizes, as reflected, for example, in the empirical mean of the H function in FIGS. 2 and 3, it is believed that this assumption is not overly restrictive.

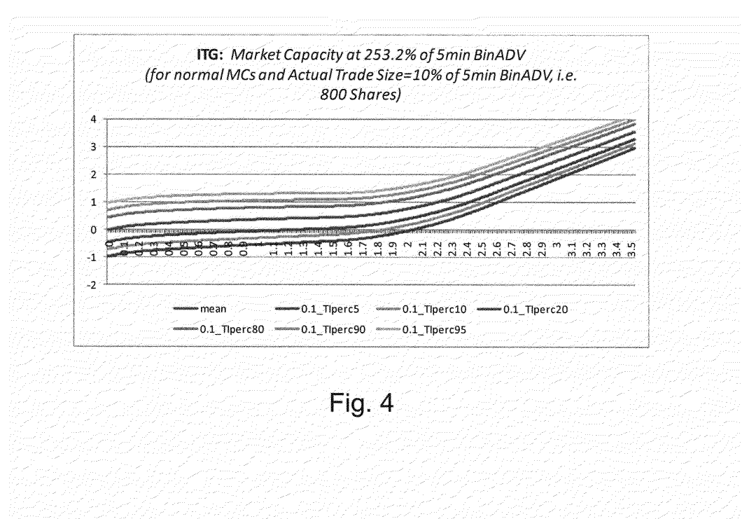

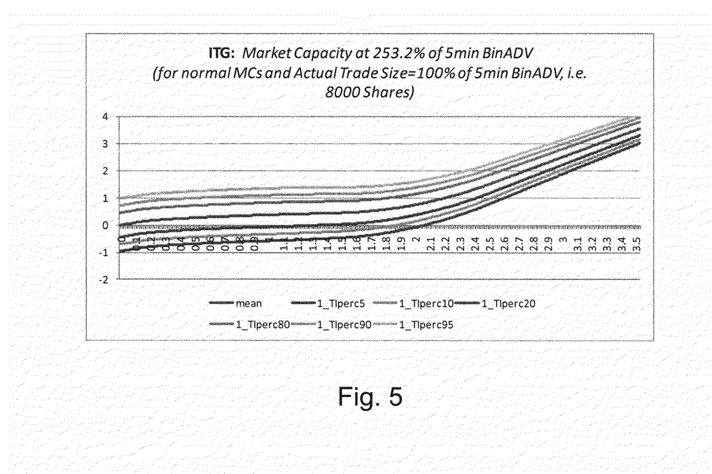

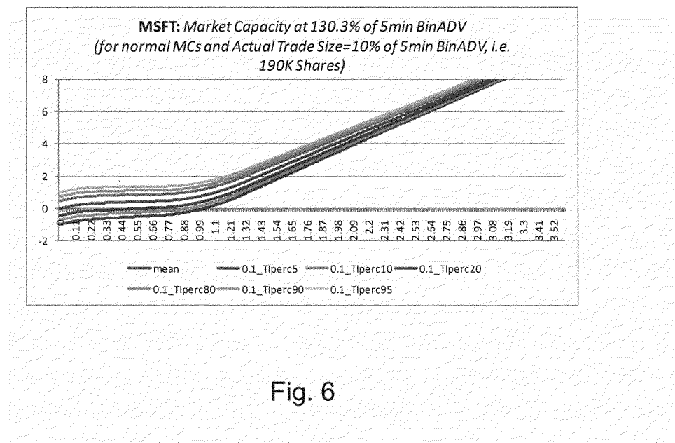

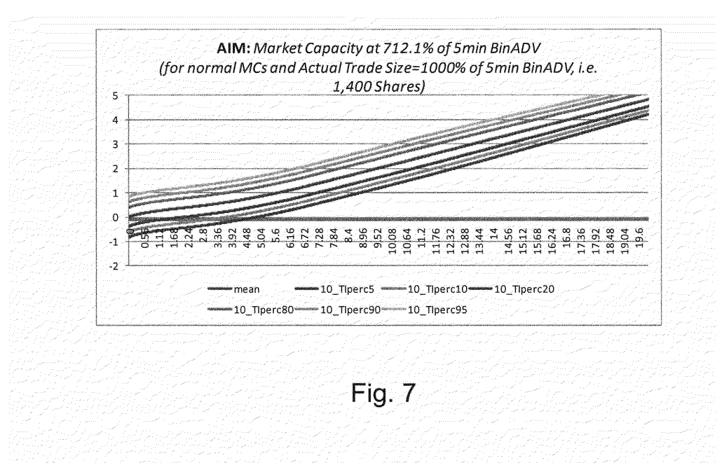

Referring to FIGS. 4-7, several example graphs of estimated mean standardized trade imbalances conditioned on normal market conditions, realized trade sizes, and the observed standardized trade imbalances are illustrated. For the observed trade imbalances, the graphs also show the 5^{th}-, 10^{th}-, 20^{th}- 80^{th}- 90^{th}-, and 95^{th}-percentilesof the empirical H distributions. Three different stocks are considered for illustration: liquid (MSFT, see FIG. 6), medium liquid (ITG, see FIGS. 4 and 5), and illiquid (AIM, see FIG. 7). The curves represent the estimated percentiles for the standardized trade imbalance conditional on the hypothetical trade size under normal market conditions. By definition, when the hypothetical trade size equals the observed trade size, the standardized trade imbalance matches the observed trade imbalance.

In a preferred embodiment of the invention, and in accordance with the above description, a model algorithm includes the following procedure:

First, the client's orders are collected, and the executions of the orders are divided into bins.

Second, for each bin, an observation of the shares traded by the client, the prevailing market conditions and trade imbalances in the market per each client order is made.

Third, using the F function, the probability distribution of the return (net of the market effect and other systematic factors) for the realized number of shares traded and for the market conditions for each bin on that day is calculated. In this manner, a calculation is made to show how the return would look if the market conditions, including the contemporaneous trade imbalances that day, were known, and if the shares of a given order traded in each bin were known.

Fourth, the data relating to the actual return are compared with the model predicted trade return distribution. For example, does the actual return fall on the 30^{th} percentile, or the 70^{th} percentile, or some other percentile value of the net return distribution. If the actual return is higher than the 50^{th} percentile of the net return distribution, then, for a given trade imbalance, the return is likely going to be higher than the median value obtained from the model estimation. The deviation from the median can most likely be attributed to the factors other than the market conditions accounted for by the model, including any known trading for the given client orders. The determined percentile value is stored. This exercise is performed for each bin, for all of the portfolio manager's orders, thereby yielding a set of percentile values. Each percentile value is conditioned on the observed standardized trade imbalance and the realized market conditions.

Fifth, for each bin and for each stock trade, the realized G function value is compared with the predicted G function distribution given the trade imbalance and prevailing market conditions, thereby yielding a set of percentile values of the effective spread for the portions of this order traded in each bin. Thus, for each order filled by a given fund, there are two sets of percentile values associated with each bin: The first set of percentile values is used for calculating stock return (net of the market, sector, industry effects, and other systematic factors) given the trade imbalance, and the second set of percentile values is used for calculating the effective spread given trade imbalance.

By using the two sets of percentile values, one can simulate the hypothetical cost of a trading strategy by varying the shares traded in each bin. The contemporaneous trade imbalance in each bin for a hypothetical trading schedule can be estimated as described above. Instead of estimating these contemporaneous trade imbalances by using the mean or median values of the distribution functions involved, the contemporaneous trade imbalances are preferably estimated by using the corresponding percentile values discussed above.

After all of the functions, the order size, the percentile values, and any known constraints (e.g., minimum part rate, maximum part rate etc.) have been provided to the optimizer, the optimizer can determine an ex post minimum cost strategy for this order. Once the optimal strategy has been determined for each order, the simulated outcomes of each optimal strategy are compared to the realized outcomes of the strategy that the client actually implemented, and then the comparisons across all orders for a given fund are aggregated. Choosing the same percentile values as those of the realized strategy for any hypothetical strategy assumes that the effect of the actual trading related to the client order on the stock's return is fully captured by the standardized trade imbalance, non-directional market conditions, and systematic risk factors (which can include, by are not limited to, the market, sector, and industry returns). This is a model assumption based on the empirical research which has shown that the contemporaneous standardized trade imbalances in combination with the systematic risk factors explain a substantial part of the price movement for any stock.

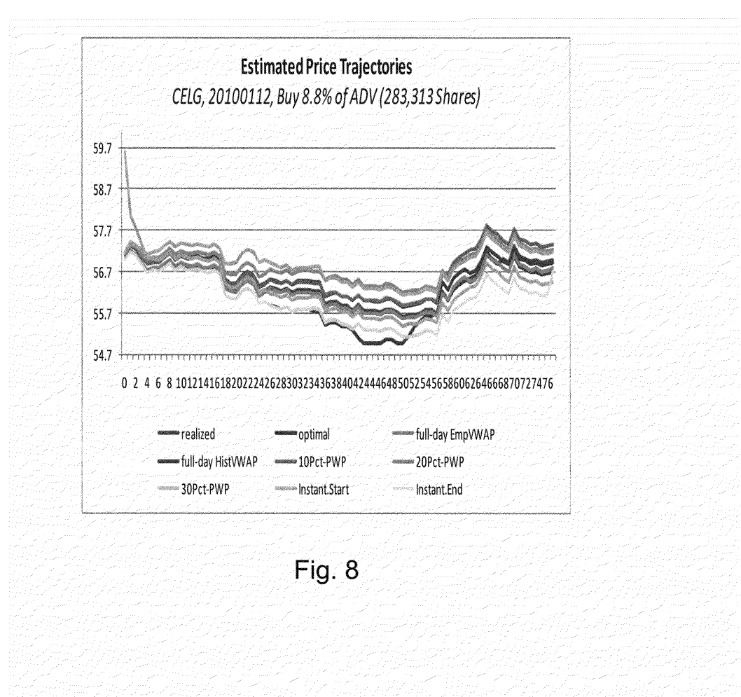

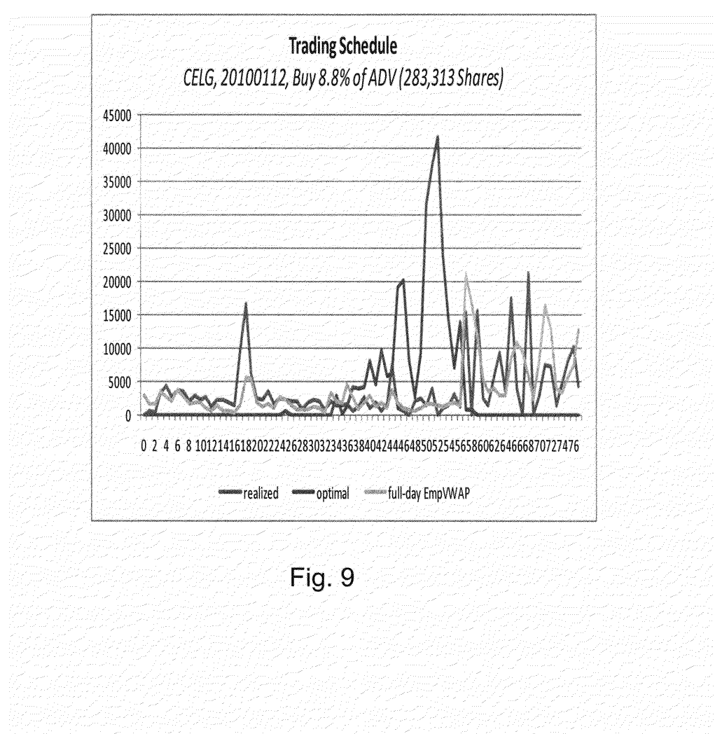

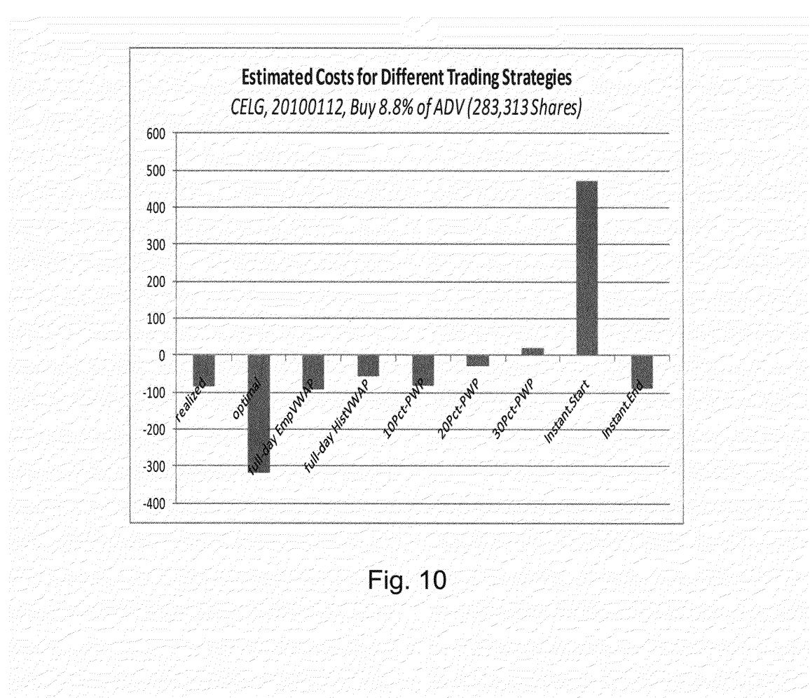

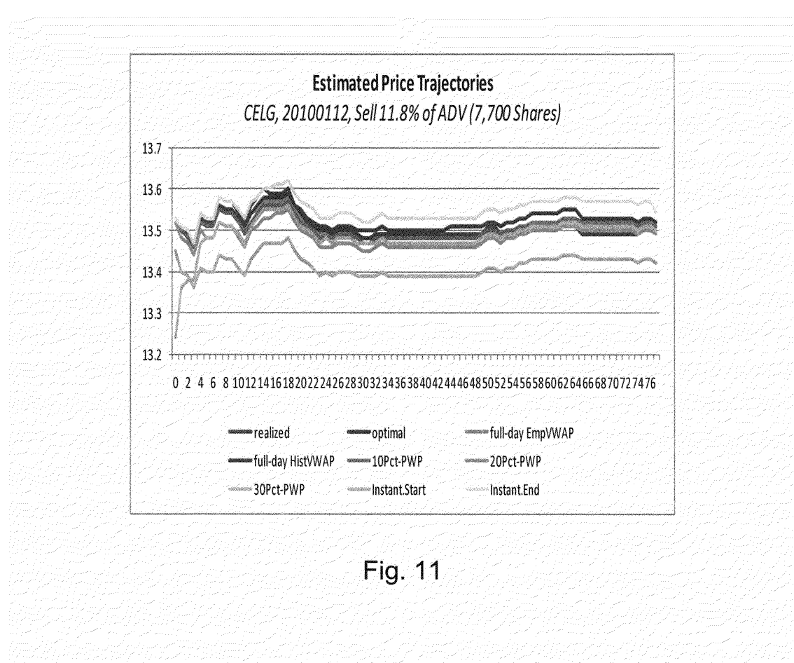

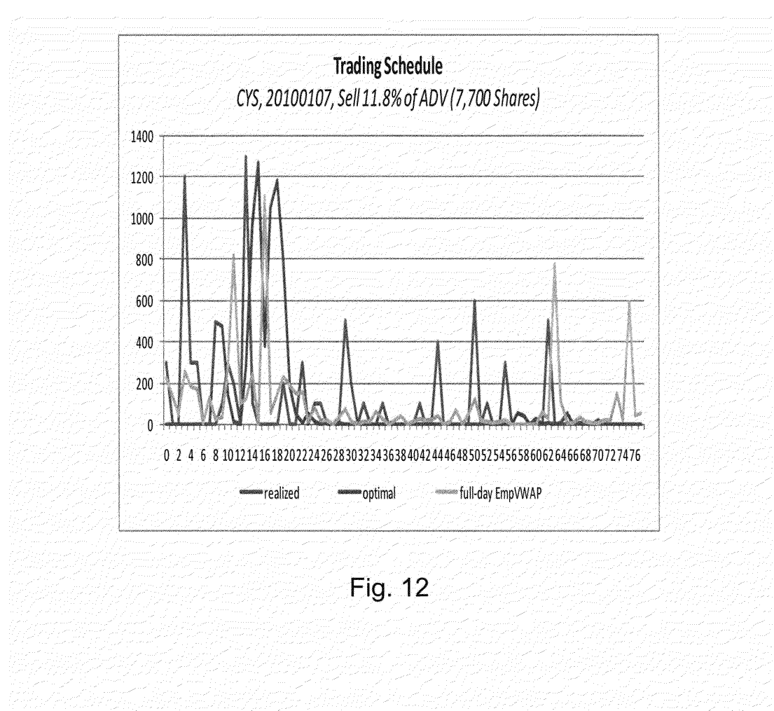

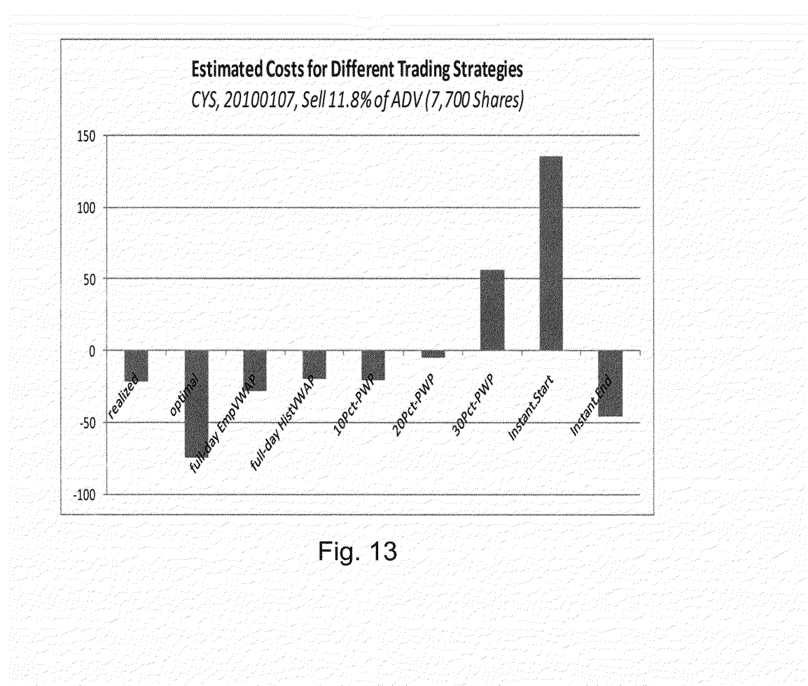

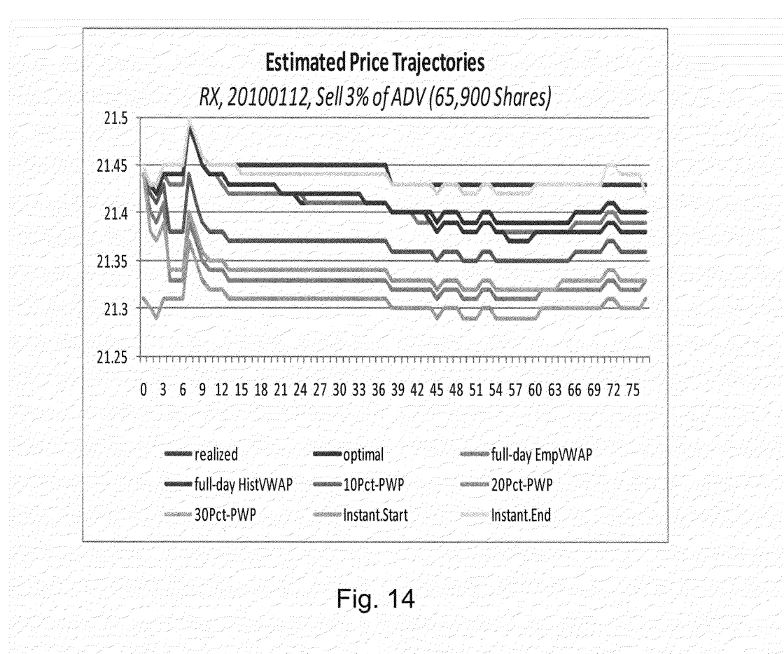

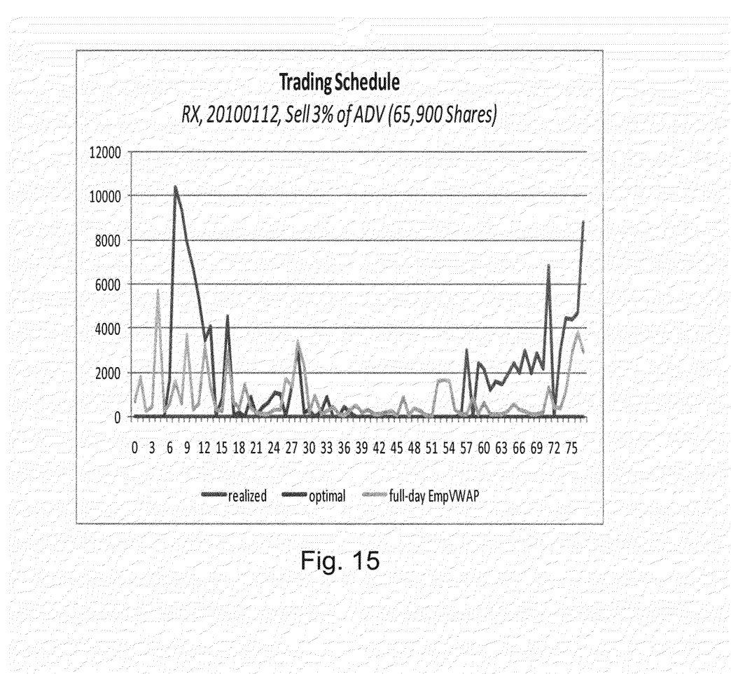

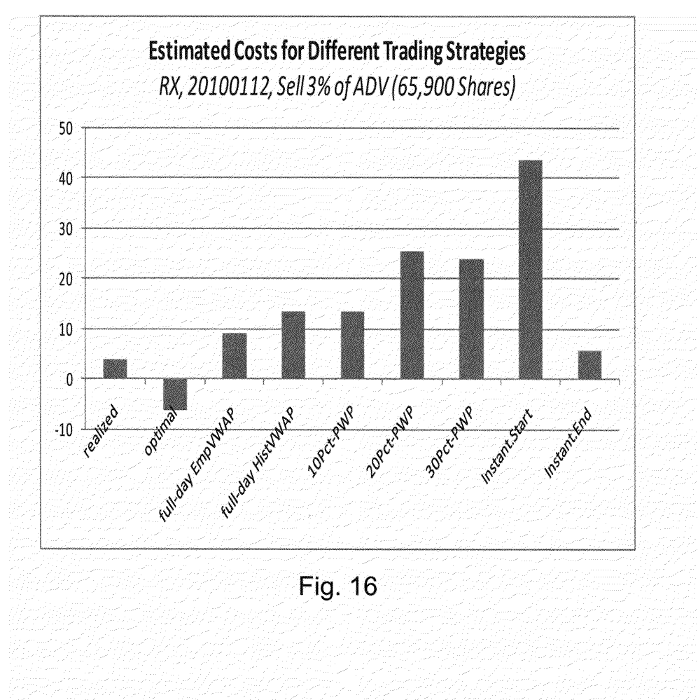

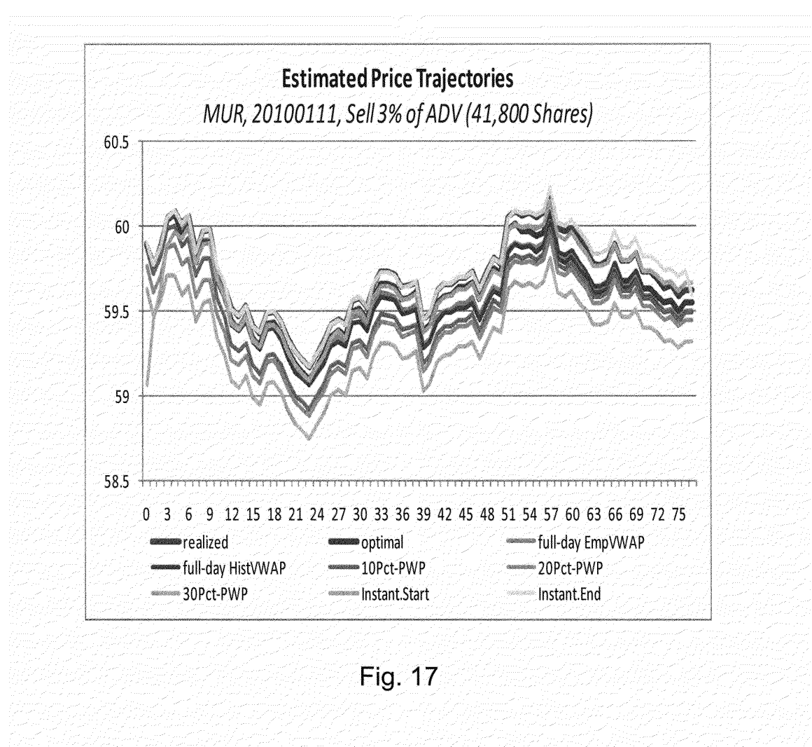

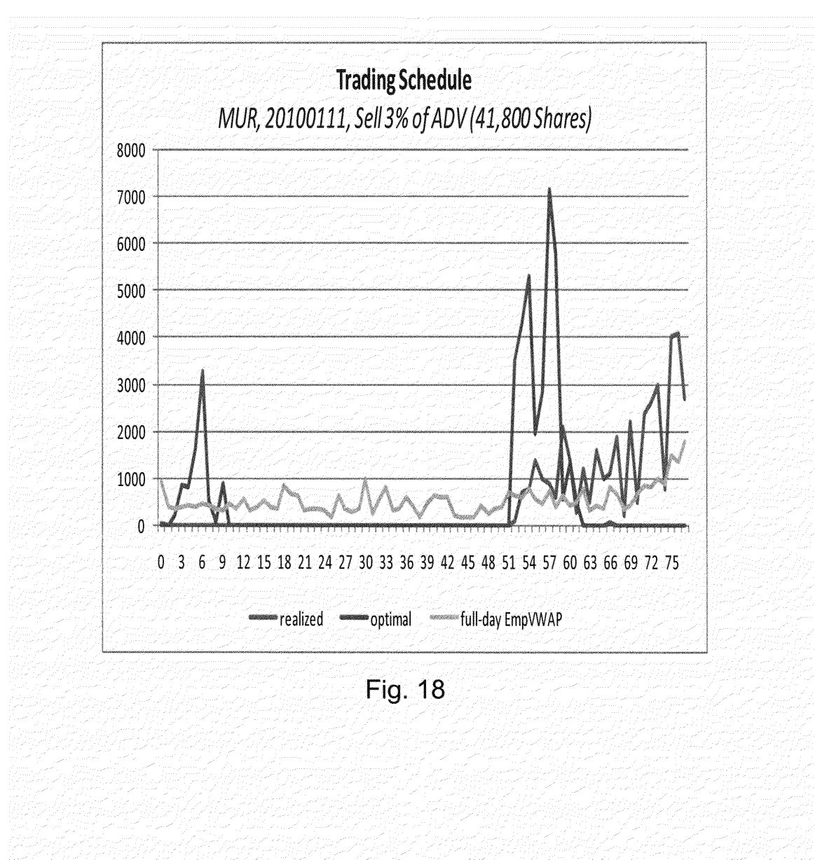

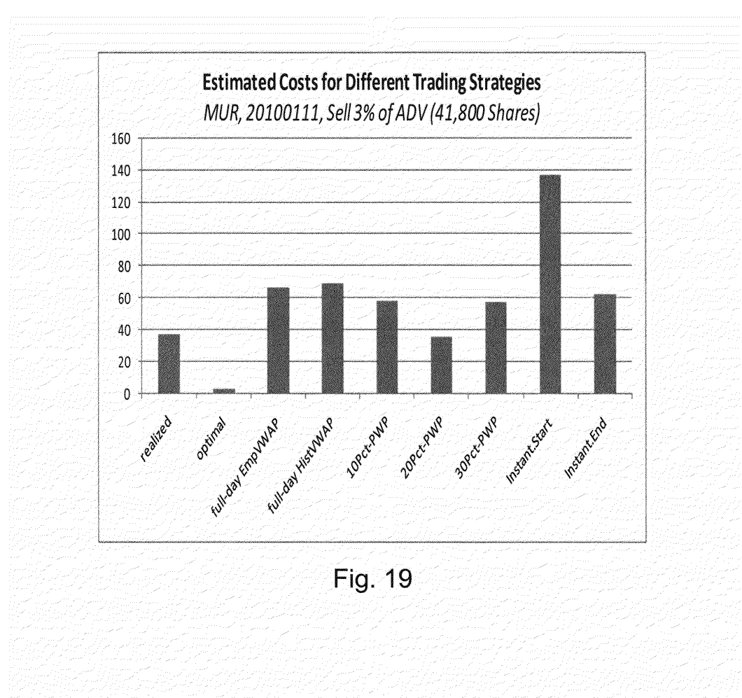

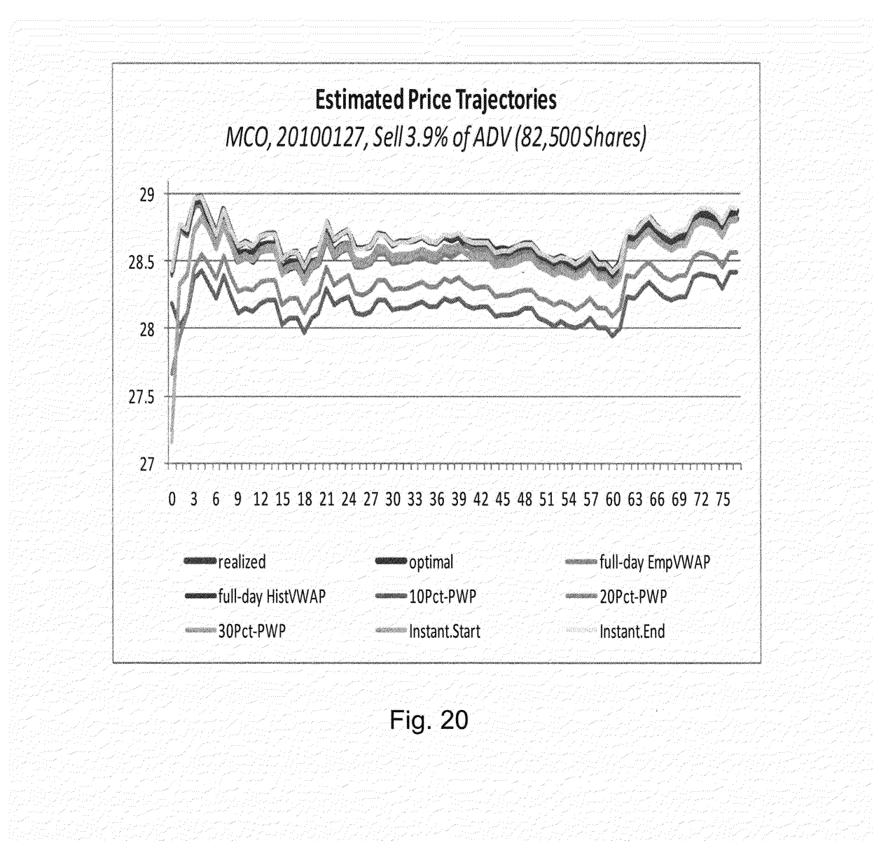

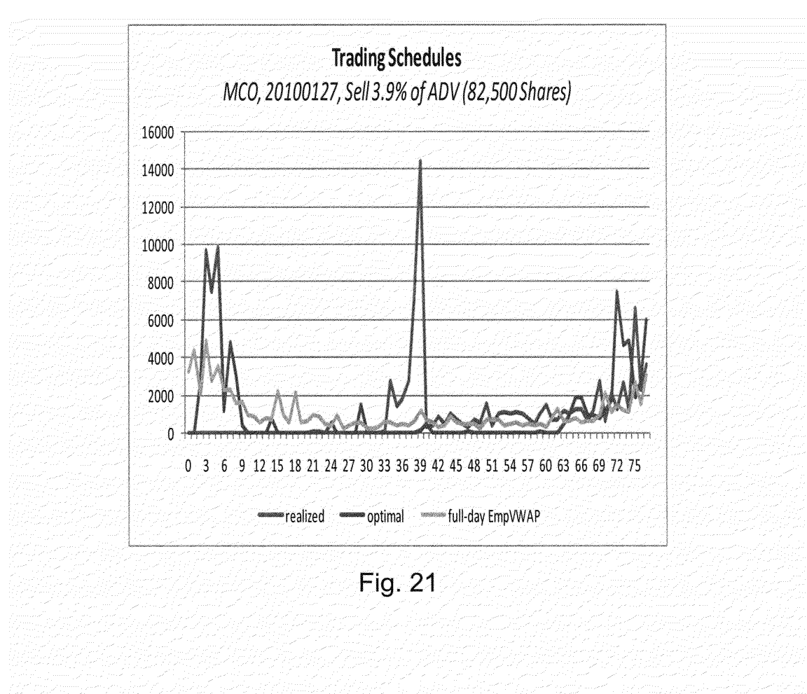

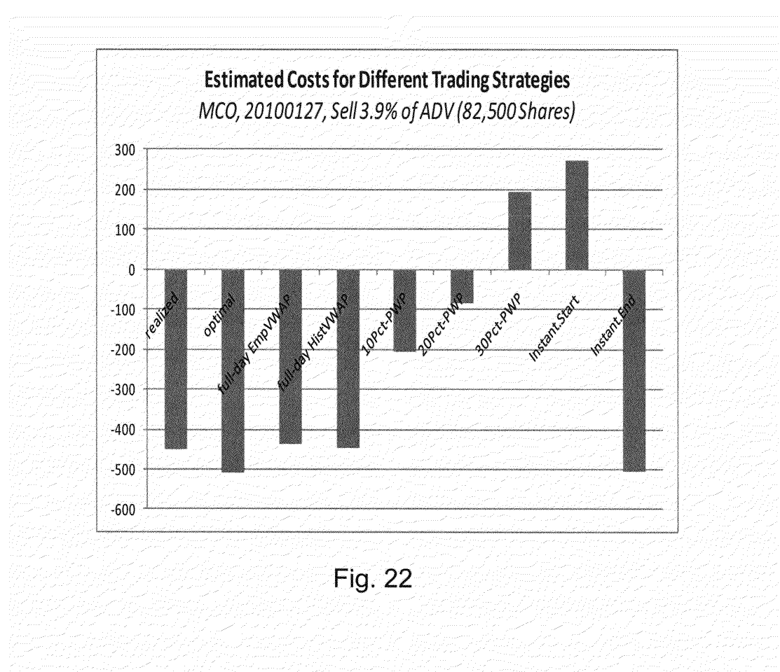

Referring now to FIGS. 8-22, several examples of estimated price trajectories/costs for different hypothetical trading strategies applied to execution of large orders are illustrated. All selected stocks are relatively liquid securities. Each of the graphs can be used to automate trading or can be themselves the outputs of the present invention. The graphs can be produced, printed, displayed or output to other functions according to the aspects of the present invention.

One objective of the present invention is to find a strategy that minimizes the ex-post cost of an order cluster. An order cluster is an aggregation of child orders for the same stock and in the same direction that were received on the same day by the trader. More precisely, an order cluster is an aggregation of child orders by trader, portfolio manager, fund, trade date, stock identification, and order side.

In this aspect, in a preferred embodiment of the invention, two approaches may be used to minimize the implementation shortfall costs, or, more precisely, the alpha leakage of an order cluster (i.e., the decrease in the risk-adjusted return of the investment based on the idiosyncratic risk of the particular stock but not the overall market risk). The first approach is to minimize total costs, and the second approach is to minimize net costs with respect to the general market movement, which includes, but is not limited to, the market, sector and industry movements. The first approach assumes that the orders are placed at times when many other market participants are trading, possibly in other stocks, and thus there is a positive relationship between the transition/rebalancing activities and the general market movement. The second approach assumes that there is herding going on in the same stocks, but the general market movement is not systematically predictable and can take any value at any time.

To perform an ex-post pattern analysis, the outcomes of hypothetical strategies are compared to outcomes of an empirical volume weighted average price (VWAP) strategy, or to outcomes of another benchmark (reference) strategy, with ending bin 4:00 pm and variable starting bins 9:30 am, 9:35 am, 9:40 am, etc., which includes the true order arrival time, or, in a second stage, to outcomes of the optimal strategy as determined by the above description, taking into account the existing or perceived market conditions.

A cost decomposition in accordance with the above description may be performed in real time, with regular updates being provided as desired (e.g., every five minutes) for each order. The following is an example of a display that may be provided after an order execution:
Real-time execution analysis for CELG at 1:28 pm on Monday Nov. 15, 2010.
Order side: buy
Total order size: 250,000 (approx. 8.8% of ADV)
Benchmark time: 9:30am
Benchmark price: $60.85
Number executed shares so far: 170,000
Estimated cost for remaining shares: 57 b.p. (using SCE model)
Real-time TCA report (buy 170,000 shares from 9:30 am to now):

| | | Contemporaneous | |
|---|---|---|---|
| | Delay Cost | Cost | Total Cost |
| Cost for Typical | +69 | +18 | +87 |
| Market Conditions | | | |
| and Typical Returns/ | | | |
| Eff. Spreads | | | |
| Price Impact | +10 | +6 | +16 |
| Cost Caused | | | |
| by Us | | | |
| Price Impact | +59 | +12 | +71 |
| Cost Caused | | | |
| by Others | | | |
| Cost due to | −16 | −9 | −25 |
| Deviations from | | | |
| Typical Market | | | |
| Conditions (Given | | | |
| Typical Returns/ | | | |
| Eff. Spreads) | | | |
| Volatility | −22 | −15 | −37 |
| Volume | +5 | +3 | +8 |
| Spread | +1 | +3 | +4 |
| Cost due to | −27 | −5 | −32 |
| Deviations from | | | |
| Typical Returns/ | | | |
| Eff. Spreads (Given | | | |
| Observed Market | | | |
| Conditions) | | | |
| Cost due to General | +18 | +5 | +23 |
| Market Movement | | | |
| Total Cost | +44 | +9 | +53 |

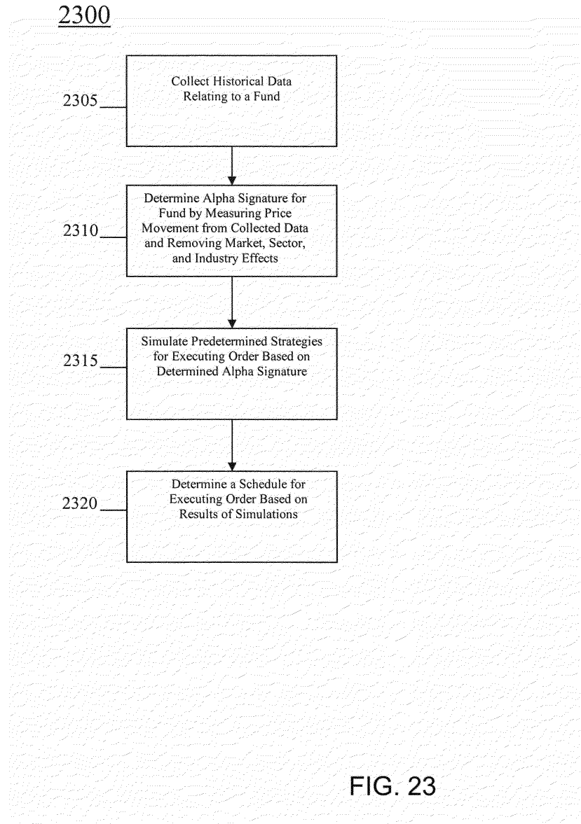

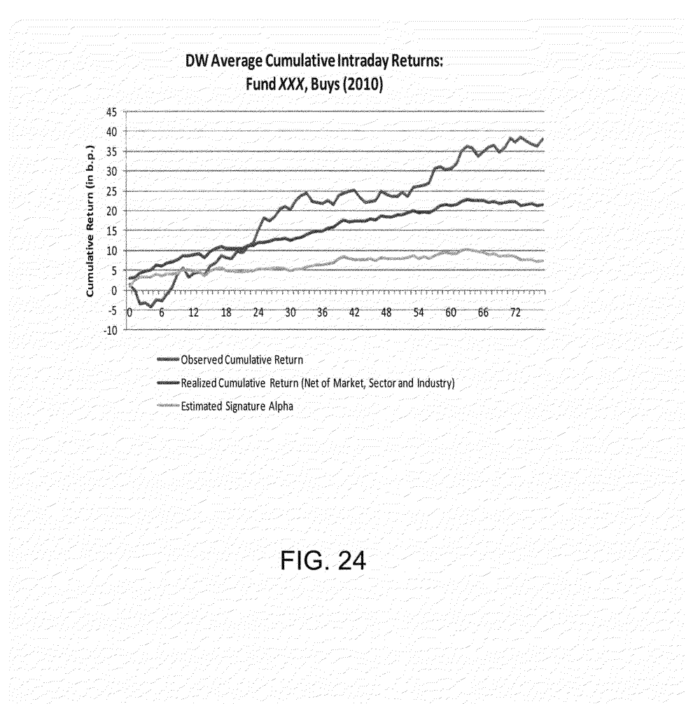

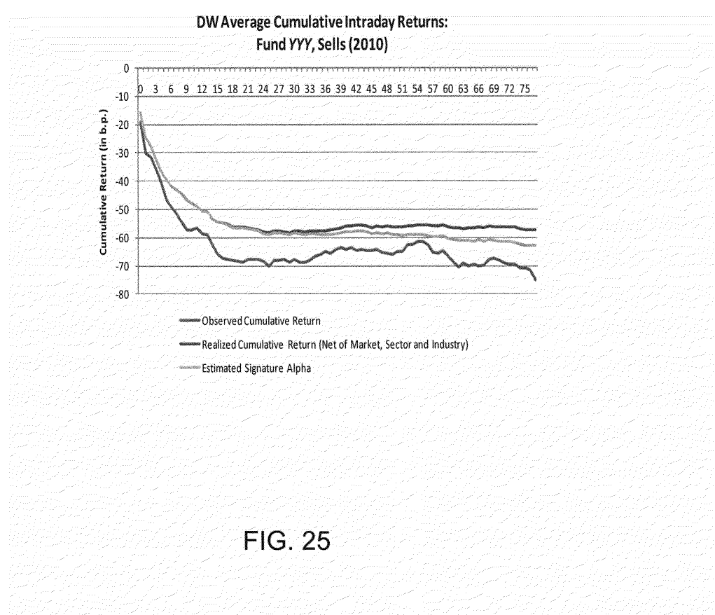

Referring now to FIG. 23, the flow chart illustrates a method for trading a security in accordance with a preferred embodiment of the present invention. In the first step 2305, historical trading data relating to a fund is collected. In the second step, an alpha profile of the fund is identified. Referring also to FIGS. 24 and 25, the determination of the alpha profile can be based on a measurement of price movement from the collected historical trading data, and a removal of systematic risk factors such as market, sector, and industry effects from the measured price movement. FIG. 24 shows a graph of the observed cumulative returns, the realized net cumulative returns, and the estimated cumulative intraday alpha profile for an exemplary set of buy transactions executed for a particular fund in a particular year. FIG. 25 shows a graph of the observed cumulative returns, the realized net cumulative returns, and the estimated cumulative intraday alpha profile for an exemplary set of sell transactions executed for a particular fund in a particular year.

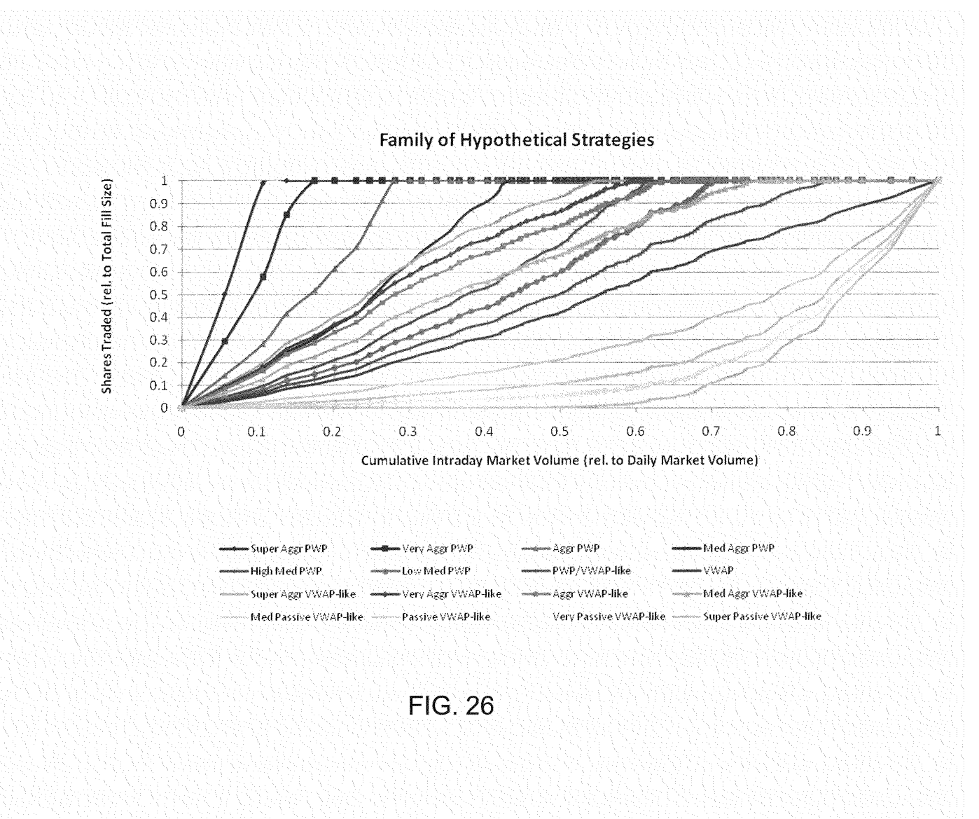

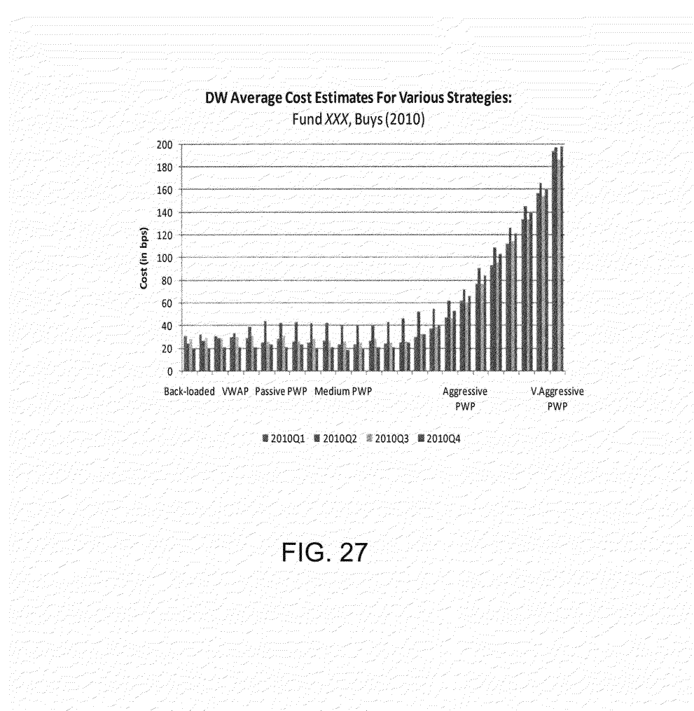

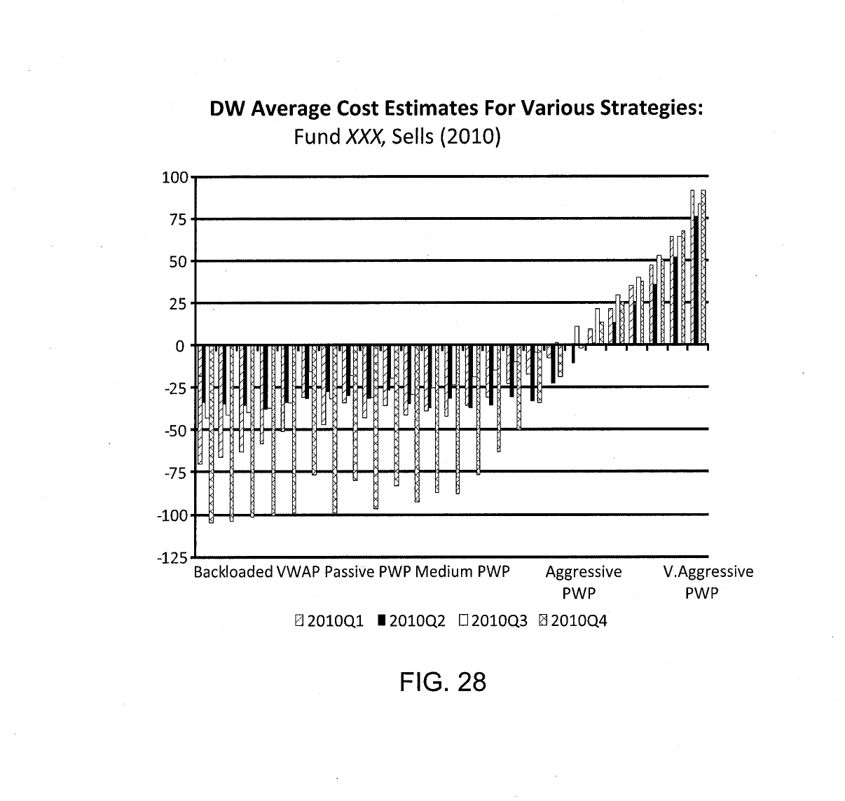

Referring also to FIGS. 26, 27, and 28, in the third step 2315, a plurality of strategies for executing an order to trade the security are simulated, based on the identified alpha profile. FIG. 26 shows a graph of cumulative intraday market volumes reported as fractions of the total daily market volumes versus the number of shares traded relative to the total fill size of cluster orders for a family of hypothetical trading strategies. FIG. 27 shows a graph of average cost estimates, based on the simulations, for a family of trading strategies applied to an exemplary set of buy order clusters executed for a particular fund in a particular year. FIG. 28 shows a graph of average cost estimates, based on the simulations, for a family of trading strategies applied to an exemplary set of sell order clusters executed for a particular fund in a particular year. In the fourth step 2320, the simulation results are used to determine a trading strategy and the resulting trading trajectories for executing the order in a security. The trading trajectory may be determined as an outcome of one of the simulated strategies.

Alternatively, the determination of the trading strategy can be customized for the specific order being executed. In addition, while the customized trading strategy is being implemented, the real time trading data can be obtained and used to adjust the customized trading strategy prior to completion of the order.

The invention thus described, as will be apparent to those skilled in the art of the trade, may be varied in many ways without departing from the spirit and scope of this invention. Any and all such modifications are intended to be included within the scope of the following claims.

We claim:

1. A computer-implemented method for trading a security, or a portfolio of securities, comprising:
(a) collecting historical trading data relating to a fund;
(b) using a computer to determine an alpha profile of the fund; and
(c) using a computer to optimize a schedule for trading the security based on the identified alpha profile,
wherein the step of using a computer to determine an alpha profile includes measuring the price movements from the collected historical trading data and removing from the measured price movement at least a market effect, a sector effect, an industry effect and an impact effect.

2. The method of claim 1, wherein the historical trading data includes price movement data and trade imbalance data.

3. The method of claim 1, wherein the step of using a computer to optimize comprises simulating inputs and outcomes of a plurality of predetermined strategies for trading the security based on the determined alpha profile.

4. The method of claim 3, wherein the step of using a computer to optimize further comprises selecting one of the simulated strategies based on the outcome of the simulations.

5. The method of claim 3, wherein the step of using a computer to optimize further comprises using a result of the simulating to generate a customized trading strategy.

6. The method of claim 5, further comprising the steps of:
obtaining real time trading data during an execution of the customized trading strategy; and
using the obtained real time trading data to adjust the customized trading strategy prior to order completion.

7. A trading platform, comprising:
a trading interface executed on a trader desktop device; and
a server computer coupled to the trading interface and coupled to at least one electronic communication network, wherein the server computer is configured to:
(a) collect historical trading data relating to a fund;
(b) identify an alpha profile of the fund; and
(c) optimize a trading strategy for a security based on the identified alpha profile,
wherein the server computer is further configured to determine an alpha profile by measuring the price movement from the collected historical trading data and removing from the measured price movement at least market effect, a sector effect, an industry effect and an impact effect.

8. The trading platform of claim 7, wherein the historical trading data includes price movement data and trade imbalance data.

9. The trading platform of claim 7, wherein the server computer is further configured to optimize by simulating a plurality of predetermined strategies for trading the security based on the identified alpha profile.

10. The trading platform of claim 9, wherein the server computer is further configured to select one of the simulated strategies based on a result of the simulations.

11. The trading platform of claim 9, wherein the server computer is further configured to use a result of the simulating to generate a customized trading strategy.

12. The trading platform of claim 11, wherein the server computer is further configured to:
obtain real time trading data during an execution of the customized trading strategy; and
use the obtained real time trading data to adjust the customized trading strategy prior to completion of the order.

13. A computer readable medium having stored thereon computer executable instructions for trading a security or a portfolio of securities when executed by performing the following operations:
(a) collecting historical trading data relating to a fund;
(b) identifying an alpha profile of the fund; and
(c) optimizing a trading strategy for the security based on the identified alpha profile,
wherein the instructions for identifying an alpha profile include instructions for measuring price movement from the collected historical trading data and removing from the measured price movement at least a market effect, a sector effect, an industry effect and an impact effect.

14. The computer readable medium of claim 13, wherein the historical trading data includes, but is not limited to, price movement data and trade imbalance data.

15. The computer readable medium of claim 13, wherein the instructions for optimizing comprise instructions for simulating a plurality of predetermined strategies for trading the security based on the identified alpha profile.

16. The computer readable medium of claim 15, wherein the instructions for optimizing further comprise instructions for selecting one of the simulated strategies based on a result of the simulations.

17. The computer readable medium of claim 15, wherein the instructions for optimizing further include instructions for using a result of the simulations to identify a customized trading strategy.

18. The computer readable medium of claim 17, wherein the computer executable instructions further include instructions for:
obtaining real time trading data during an execution of the customized trading strategy; and
using the obtained real time trading data to adjust the customized trading strategy prior to completion of the order.
